(19) United States
(12) Patent Application Publication
(10) Pub. No.: US 2025/0167614 A1
(43) Pub. Date: May 22, 2025

(54) ROTATING ELECTRIC MACHINE AND DRIVE UNIT INCLUDING THE SAME

(71) Applicant: Hitachi Astemo, Ltd., Hitachinaka-shi, Ibaraki (JP)

(72) Inventors: Tetsuya SUTO, Tokyo (JP); Akeshi TAKAHASHI, Tokyo (JP); Makoto ITO, Tokyo (JP); Toshiyuki INNAMI, Hitachinaka-shi, Ibaraki (JP)

(73) Assignee: Hitachi Astemo, Ltd., Hitachinaka-shi, Ibaraki (JP)

(21) Appl. No.: 18/841,310

(22) PCT Filed: Feb. 3, 2023
(86) PCT No.: PCT/JP2023/003609

§ 371 Date: Aug. 23, 2024

(30) Foreign Application Priority Data
Apr. 22, 2022 (JP) 2022-070696

(51) Int. Cl. H02K 3/24; H02K 7/00

(52) U.S. Cl. CPC H02K 3/24; H02K 7/006

(57) ABSTRACT

The purpose of the present invention is to provide a rotary electric machine that has a simplified structure for cooling and that inhibits the increase in production costs. In the rotary electric machine according to the present invention, the axis of rotation of a rotor shaft 26 is positioned at a prescribed angle with respect to the horizontal axis. Provided are an upper-side flow passage 252 formed on the upper side of a stator core 23a and through which the liquid refrigerant flows, a lower-side flow passage 255 formed on the lower side of the stator core 23a, and a slot flow passage 257 that connects the upper-side flow passage 252 and the lower-side flow passage 255. The upper-side flow passage 252 is formed by a housing 25, an upper end surface of the stator core 23a, and an upper-side flow passage forming body 251 connecting the housing 25 to the upper end surface of the stator core 23a on a gap G side. The slot flow passage 257 is at least partially open at the end face on the gap G side.

### TECHNICAL FIELD

The present invention relates to a rotating electric machine and a drive unit including the same.

### BACKGROUND ART

The electrification of automobiles is progressing toward a decarbonization and autonomous driving society. With electrification, various techniques for cooling a rotating electric machine have been proposed. As an example thereof, there is a technique in which an oil pump is connected to a rotating electric machine in which a rotation axis is arranged in a horizontal direction, and cooling oil is pressure-fed into the rotating electric machine to cool a stator and a rotor inside the rotating electric machine. In this technique, since the inside of the rotating electric machine is filled with the cooling oil, and the rotor rotates while being immersed in the cooling oil, fluid friction loss occurs in the rotor.

To solve this problem, there is a technique described in PTL 1. In PTL 1, a stator and a rotor are disposed in a case of a rotating electric machine. A plurality of slots are formed in a stator core of the stator, and coils are arranged in the slots. In the rotor-side opening of the slot, a resin layer is disposed and hermetically sealed so as to connect the tooth tip portions. In addition, a cylindrical portion is disposed between the case and the stator core, and a seal member is disposed in a gap between the cylindrical portion and the stator core. With this configuration, the coil disposed in the slot of the stator core is disposed in the hermetically sealed space by the case, the cylindrical portion, and the resin layer. In PTL 1, cooling oil is caused to flow in the hermetically sealed space to cool the coil end of the coil.

### CITATION LIST

### Patent Literature

PTL 1: JP 2006-87165 A

### SUMMARY OF INVENTION

### Technical Problem

However, in the technique described in PTL 1, since the resin layer is disposed to connect the tooth tip portions, and furthermore, the seal member is disposed in the gap between the cylindrical portion and the stator core, there is a problem that the structure becomes complicated, so that the productivity of the rotating electric machine decreases, and the production cost increases.

An object of the present invention is to solve the above problems and to provide a rotating electric machine in which a structure for cooling is simplified and an increase in production cost is suppressed, and a drive unit including the rotating electric machine.

### Solution to Problem

In order to achieve the above object, the present invention is a rotating electric machine including: a stator core having a cylindrical shape, the stator core having a plurality of slots into which coils are mounted; a rotor core facing the stator core in a radial direction of the stator core with interposition of a predetermined gap; a rotor shaft configured to rotate together with the rotor core; and a housing configured to house the stator core, the rotor core, and the rotor shaft, in which a rotation axis of the rotor shaft is disposed at a predetermined angle with respect to a horizontal axis, the rotating electric machine further includes: an upper flow path which is formed on an upper side of the stator core and through which a liquid refrigerant flows, a lower flow path formed on a lower side of the stator core, and a slot flow path communicating the upper flow path and the lower flow path, the upper flow path is formed by the housing, an upper end surface of the stator core, and an upper flow path forming body that connects the housing and an upper end surface on a gap side of the stator core, and in the slot flow path, at least a part of an end surface on the gap side is opened.

### Advantageous Effects of Invention

According to the present invention, it is possible to provide a rotating electric machine in which a structure for cooling is simplified and an increase in production cost is suppressed, and a drive unit including the rotating electric machine.

### BRIEF DESCRIPTION OF DRAWINGS

FIG. 1 is a configuration diagram showing a vehicle 100 mounted with a drive unit 1 according to a first embodiment of the present invention.

FIG. 2 is a component exploded perspective view showing the drive unit 1 according to the first embodiment of the present invention.

FIG. 3 is a component exploded perspective view showing the drive unit 1 in which the motor 2 is disassembled according to the first embodiment of the present invention.

FIG. 4 is a perspective view cut in half in a longitudinal section showing the drive unit 1 according to the first embodiment of the present invention.

FIG. 5 is a longitudinal sectional view showing the drive unit 1 according to the first embodiment of the present invention.

FIG. 6A is an enlarged cross-sectional perspective view in which a rotor is excluded from the motor according to the first embodiment of the present invention.

FIG. 6B is an enlarged view of the VIB portion in FIG. 6A.

FIG. 7 is a schematic cross-sectional view of a part of the motor according to the first embodiment of the present invention.

FIG. 8 is a schematic view showing the flow of a liquid refrigerant according to the first embodiment of the present invention.

FIG. 9 is a schematic view of a part of the motor 2 according to a comparative example as viewed from the axial direction.

FIG. 10 is a schematic view of a part of the motor 2 according to the first embodiment of the present invention as viewed from the axial direction.

FIG. 11 is an enlarged cross-sectional perspective view in which a rotor is excluded from the motor according to the second embodiment of the present invention.

FIG. 12 is a schematic cross-sectional view of a part of the motor according to the second embodiment of the present invention.

FIG. 13 is a schematic view showing the flow of a liquid refrigerant according to the second embodiment of the present invention.

FIG. 14 is a schematic cross-sectional view of a part of the motor according to the third embodiment of the present invention.

FIG. 15 is a schematic view showing the flow of a liquid refrigerant according to the third embodiment of the present invention.

FIG. 16 is a perspective view cut in half in a longitudinal section showing the drive unit 1 according to the fourth embodiment of the present invention.

FIG. 17 is a cross-sectional view of the drive unit 1 according to the fourth embodiment of the present invention as viewed from the drive shaft 106 side.

FIG. 18 is a cross-sectional view of the drive unit 1 when the vehicle is in a deceleration state or a hill-descending state.

FIG. 19 is a cross-sectional view of the drive unit 1 when the vehicle is in an acceleration state or a hill-ascending state.

### DESCRIPTION OF EMBODIMENTS

Hereinafter, embodiments of the present invention will be described with reference to the accompanying drawings. The same components are denoted by the same reference numerals, and the same description will not be repeated.

The various components of the present invention do not necessarily need to be individually independent and allow one component to be composed of a plurality of members, a plurality of components to be composed of one member, a certain component to be a part of another component, a part of one component and a part of another component to overlap, and the like.

In each drawing, the U direction is the upward direction, the D direction is the downward direction, the F direction is the front direction, the B direction is the back direction, the R direction is the right direction, and the L direction is the left direction.

### First Embodiment

### Overall Configuration of Vehicle 100

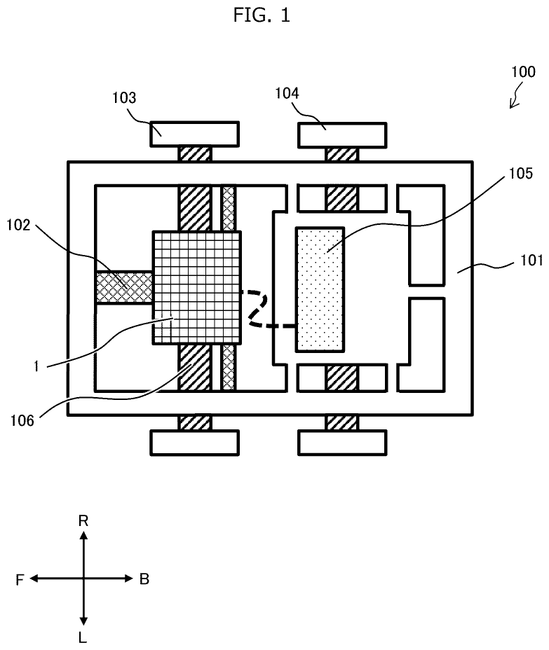

FIG. 1 is a configuration diagram showing a vehicle 100 mounted with a drive unit 1 according to a first embodiment of the present invention.

The vehicle 100 includes a drive unit 1 disposed at the center, a chassis 101 mounted with the drive unit 1, a support member 102 that fixes the drive unit 1 to the chassis 101, wheels 103 which are front wheels disposed in a front direction F of the vehicle 100, wheels 104 which are rear wheels disposed in a back direction B of the vehicle 100, and a battery 105 that supplies power to the drive unit 1.

The drive unit 1 is housed in an engine room between the wheels 103 in the front direction F of the vehicle 100. The drive unit 1 is connected to the wheels 103 through a drive shaft 106.

The drive shaft 106 connects the differential side gear and the wheel. The drive shaft 106 extends in the right direction R and the left direction L. Since the suspension is movable, two constant-velocity joints are provided between the drive shaft 106 and the wheel. Here, the drive shaft 106 is defined as a portion from the drive unit 1 to the first constant-velocity joint.

It should be noted that the drive unit 1 may be housed between the wheels 104 in the back direction B of the vehicle 100 to drive the wheels 104, or two drive units may be mounted and each disposed between the wheels 103 and between the wheels 104 to drive four wheels.

### Drive Unit 1

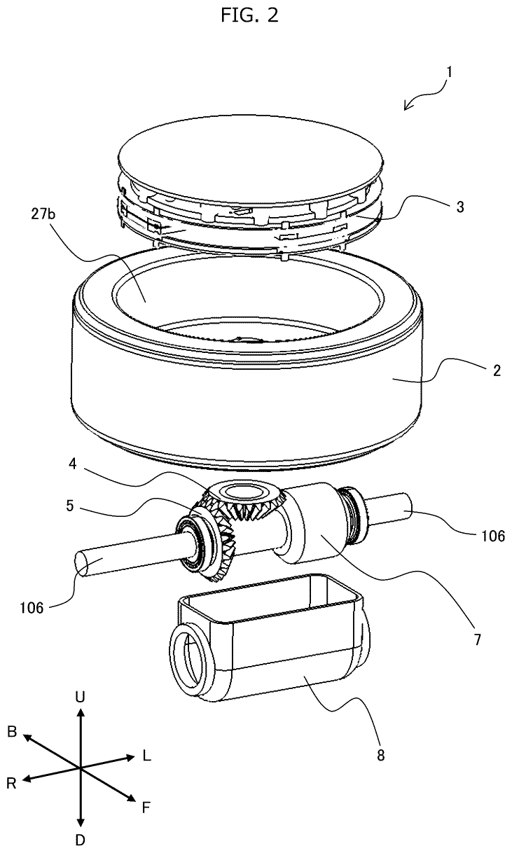

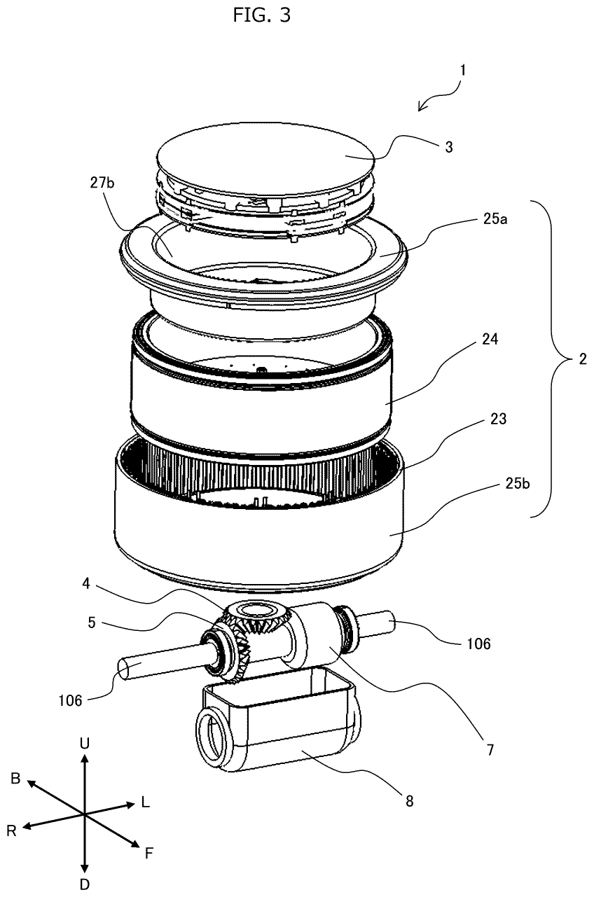

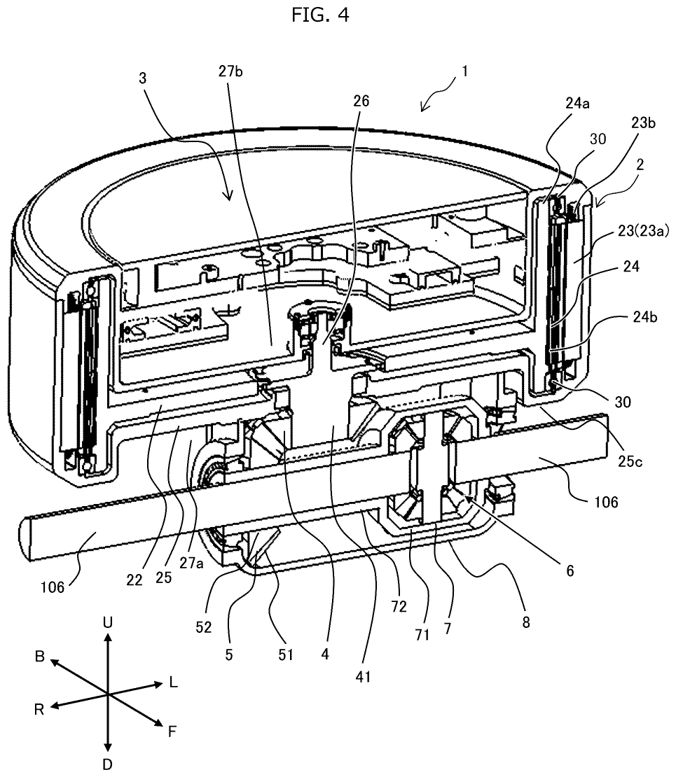

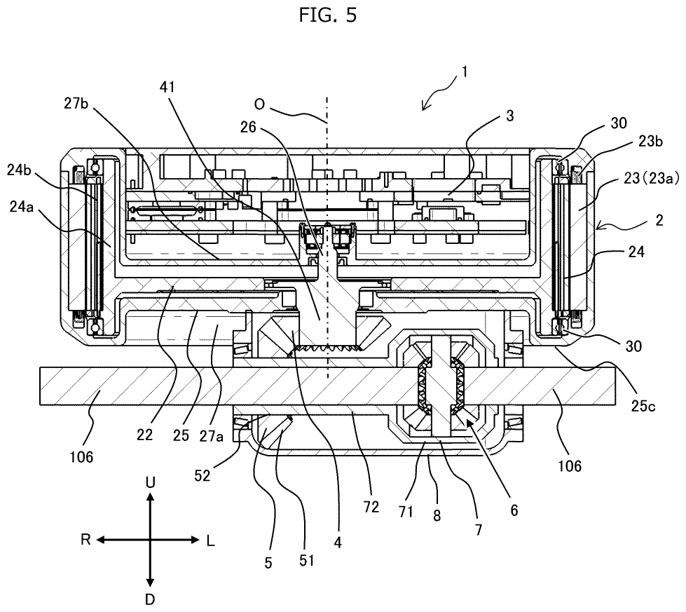

FIG. 2 is a component exploded perspective view showing the drive unit 1 according to the first embodiment of the present invention. FIG. 3 is a component exploded perspective view showing the drive unit 1 in which the motor 2 according to the first embodiment of the present invention is disassembled. FIG. 4 is a perspective view cut in half in a longitudinal section showing the drive unit 1 according to the first embodiment of the present invention. FIG. 5 is a longitudinal sectional view showing the drive unit 1 according to the first embodiment of the present invention.

The drive unit 1 includes a motor 2 as a rotating electric machine, an inverter 3, a bevel gear 4, a ring gear 5, a distribution mechanism 6, a differential case 7, and a differential housing 8.

### Motor 2 (Rotating Electric Machine)

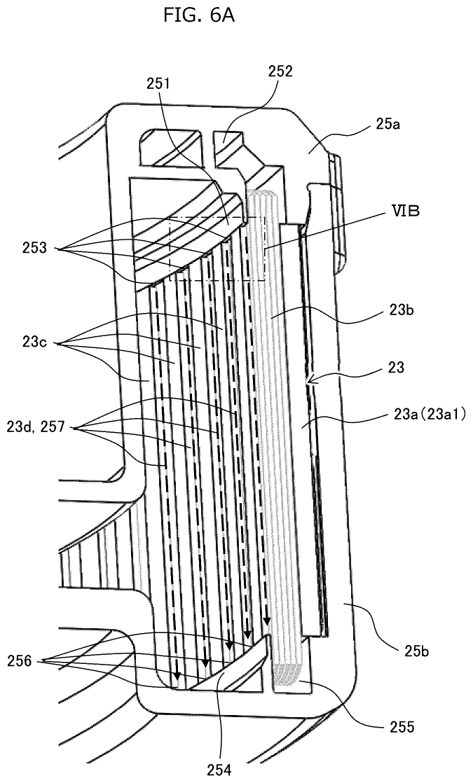

The motor 2 includes a rotor 24 having a rotor cylindrical portion 24a, a stator 23 having a cylindrical stator core 23a and a coil 23b mounted in a plurality of slots 23d (FIG. 6A) formed between a plurality of teeth 23c of the stator core 23a, a rotor shaft 26 fixed to an inner circumferential side of the rotor 24 and rotating together with the rotor 24, a connecting portion 22 connecting the rotor shaft 26 and the rotor cylindrical portion 24a, a gear shaft 41 integrated with the rotor shaft 26, and a housing 25 housing these members. In addition, the rotor cylindrical portion 24a is provided with a rotor core 24b. The rotor core 24b is disposed so as to face the stator core 23a with the interposition of a predetermined gap G in the radial direction of the stator core 23a.

It should be noted that the motor 2 of the present embodiment is disposed so that the rotation axis (rotation central axis O) is along the vertical direction.

### Inverter 3

The inverter 3 converts DC power supplied from the battery 105 into AC power and supplies the AC power to the motor 2.

### Bevel Gear 4

The bevel gear 4 is disposed on the rotation axis (rotation central axis 0) of the motor 2, and the driving force of the motor 2 is transmitted through the connecting portion 22 connected to the rotor cylindrical portion 24a. The bevel gear 4 is provided at the axially lower end portion of the gear shaft 41 integrated with the rotor shaft 26, and the rotational driving force of the rotor 24 is transmitted.

The bevel gear 4 is connected to the rotor 24 through the connecting portion 22 and the rotor cylindrical portion 24a. The bevel gear 4 is smaller in size than the ring gear 5 and also serves as a reduction gear.

It should be noted that as the bevel gear 4, a miter bevel gear having the same number of teeth as the ring gear 5 and having a tooth tip at a reduction ratio of 1:1 of 45° with respect to the rotation center may be used. However, when the miter bevel gear is used, the total mass of the bevel gear 4 and the ring gear 5 increases. Therefore, the bevel gear 4 is used in a combination of the bevel gear 4 and the ring gear 5 of appropriate sizes.

The bevel gear 4 is classified by the shape of the tooth tip and includes a spiral bevel gear and a straight bevel gear.

In the spiral bevel gear, the tooth tip draws a curve, and it is difficult to manufacture the spiral bevel gear, but since the contact ratio is further increased, the occurrence of vibration and noise is suppressed. However, since a thrust load is generated in the axial direction in the spiral bevel gear, it is necessary to pay attention during use.

The straight bevel gear has a small thrust load, and the direction of the thrust load is also always limited to a direction away from the straight bevel gear. Therefore, the straight bevel gear has an advantage that the bearing structure can be simplified.

In the first embodiment, a spiral bevel gear is used as the bevel gear 4. However, the tooth tip shape of the bevel gear 4 is not limited.

### Gear Shaft 41

The gear shaft 41 extends in an axial direction which is a longitudinal direction toward the upward direction U and the downward direction D. The gear shaft 41 is a cylindrical member. The bevel gear 4 is fixed to a lower end portion in the downward direction D of the gear shaft 41.

### Ring Gear 5

The ring gear 5 is disposed with its rotation center facing the radial direction of the motor 2. The ring gear 5 is fixed to the differential case 7 and meshes with the bevel gear 4.

The ring gear 5 is disposed so that the rotation center faces the left direction L which is the gear shaft 41 side, that is, the inner diameter direction of the motor 2. The ring gear 5 includes a gear tooth surface portion 51 facing the left direction L and having a gear tooth at a predetermined taper angle, and an inner circumferential surface portion 52 facing the drive shaft 106 direction of the gear tooth surface portion 51. The inner circumferential surface portion 52 is connected to the differential case 7.

### Distribution Mechanism 6

The distribution mechanism 6 transmits the driving force of the motor 2 to the drive shaft 106 (axle) through the bevel gear 4 and the ring gear 5. The distribution mechanism 6 and the ring gear 5 are arranged opposite to each other around the rotation axis (rotation central axis O) of the rotor shaft 26 (motor 2).

The distribution mechanism 6 is a mechanism that evenly distributes the torque transmitted from the motor 2 by one shaft to the two drive shafts of the drive shaft 106. The turning radius of the wheel 103 during the cornering of the vehicle 100 is different between the inner wheel and the outer wheel. Therefore, the moving distance of the outer wheel becomes longer than that of the inner wheel, and the rotational speed also becomes larger. The distribution mechanism 6 transmits the same torque to both the left and right wheels 103 while giving a rotational speed difference (also referred to as a differential) to the left and right wheels 103.

A general bevel gear type distribution mechanism includes a final drive gear (bevel gear 4), a ring gear 5 (final driven gear), a differential case 7, a differential side gear, a differential pinion, and a differential pinion shaft. The driving force from the motive power generation source of the motor 2 is transmitted to the ring gear 5 integrated with the differential case 7 using the final drive gear, and is transmitted to the drive shaft 106 by rotating the differential pinion and the differential pinion shaft together with the differential case 7 and turning the differential side gear connected to the drive shaft 106.

The differential pinion can rotate, in addition to revolving together with the differential case 7. When the right and left drive wheels receive equal resistance from the road surface in the straight traveling state, the differential pinion revolves together with the differential case 7 to transmit the driving force to the differential side gear. At this time, the differential pinion does not rotate.

When there is a difference in resistance received by the left and right wheels 103 from the road surface, the differential pinion rotates while revolving. Since the rotation of the differential pinion causes a rotational speed difference between the left and right differential side gears, the rotational speed difference between the left and right wheels 103 is absorbed.

### Differential Case 7

The differential case 7 houses the distribution mechanism 6 and transmits the driving force of the ring gear 5 to the distribution mechanism 6. The distribution mechanism 6 and the ring gear 5 are disposed across the rotation axis (rotation central axis O) of the motor 2. The differential case 7 is a cylindrical member surrounding the distribution mechanism 6 and the two drive shafts 106.

The differential case 7 includes a large cylindrical portion 71 and a small cylindrical portion 72. The large cylindrical portion 71 is a cylindrical member and covers the distribution mechanism 6. The small cylindrical portion 72 is a cylindrical member having a smaller diameter than the large cylindrical portion 71, and connects the inner circumferential surface portion 52 of the ring gear 5 having no tooth and the large cylindrical portion 71. Accordingly, the bevel gear 4 is disposed in a space surrounded by the ring gear 5, the large cylindrical portion 71, and the small cylindrical portion 72.

### Differential Housing 8

The differential housing 8 opens on the upper side in the motor axial direction which is the upward direction U and covers the differential case 7. The opening of the differential housing 8 is covered with the housing 25.

### Details of Motor 2

### Connecting Portion 22

The connecting portion 22 connects the gear shaft 41 and the rotor 24 at the center in the axial direction of the rotor 24. The connecting portion 22 has a disk shape, and a hole portion is formed at the center thereof. The connecting portion 22 is connected to the gear shaft 41 passed through the hole portion at the inner diameter end portion.

The connecting portion 22 is made of a material (a material having a large Young's modulus) which is hardly deformed such as a metal or a carbon fiber composite resin together with the rotor cylindrical portion 24a. The connecting portion 22 has a function of a rib for enhancing rigidity in the radial direction and preventing deformation in the radial direction by having a disk shape, and also has a function of rotation transmission.

### Stator 23

The stator 23 has a cylindrical shape longer in a radial direction that is a lateral direction including the front direction F, the back direction B, the right direction R, and the left direction L than in the axial direction.

The stator 23 is manufactured by laminating electromagnetic steel sheets. Since the stator 23 has a large-diameter cylindrical shape, the split core has a better material yield. However, it is difficult to consider a support structure for the stator 23 to withstand large torque. In the integrated core, the material yield is poor when considered alone, but the yield can be improved by punching out the rotor 24 and the core of another product from the disk residual portion of the stator core inner circumferential portion. Since the stator 23 has higher rigidity when connected to the cylinder, the structural design is easier than that of the split core. The stator 23 may be wound in a concentrated winding or in a sectional winding, but the stator has a large diameter, and the sectional winding has a larger coil length, so that the concentrated winding is more advantageous.

### Rotor 24

The rotor 24 is a cylindrical member radially opposed to the stator 23. The rotor 24 is disposed on the inner circumferential side of the stator 23. That is, the rotor 24 is a cylindrical member disposed on the inner diameter side of the stator 23 and facing the stator 23.

The rotor 24 includes a rotor cylindrical portion 24a having a cylindrical shape, a rotor core 24b arranged in the circumferential direction of the rotor cylindrical portion 24a, and a plurality of magnetic pole portions arranged in the rotor core 24b. Similarly to the stator 23, the rotor 24 is manufactured by laminating electromagnetic steel sheets. Since the rotor 24 has a large-diameter cylindrical shape, the split core has a better material yield. However, it is difficult to consider a support structure for the rotor 24 to withstand large torque. The rotor 24 is an inner rotor disposed on the inner circumferential side of the stator 23, but may be an outer rotor. In addition, the rotor 24 may be an induction motor or a permanent magnet motor, and the type of the rotor 24 is not limited. The rotor 24 here is a permanent magnet synchronous motor.

### Housing 25

The housing 25 houses the stator 23 and the rotor 24. The housing 25 houses the gear shaft 41, the stator 23, the rotor 24, and the connecting portion 22, and causes the lower end portion in the axial direction of the gear shaft 41 to protrude in the downward direction D. The housing 25 has a longitudinal section H shape.

The housing 25 includes an upper half body 25a and a lower half body 25b. The upper half body 25a is a lid-shaped member that covers the box-body-shaped lower half body 25b opened in the upward direction U that holds the stator 23 and the rotor 24. In the lower half body 25b, the axially upper end portion is formed higher than the axially upper end portions of the stator 23 and the rotor 24 in order to hold the stator 23 and the rotor 24.

The outer circumferential lower surface 25c of the housing 25 is disposed at a position overlapping at least a part of the distribution mechanism 6 when viewed from a direction orthogonal to the rotation axis (rotation central axis O) of the motor 2. The outer circumferential lower surface 25c of the housing 25 refers to a surface positioned on the lowermost side (drive shaft 106 side) in the housing 25.

The housing 25 is a housing that supports the stator 23, the rotor 24, bearings, and the like, and is engaged with the chassis 101. A first recessed portion 27a recessed upward is formed on the lower surface of the housing 25. The height of the entire drive unit 1 is reduced by housing the differential case 7 in the first recessed portion 27a. A second recessed portion 27b recessed downward is formed on the upper surface of the housing 25. Electric components such as the inverter 3 are housed in the second recessed portion 27b. Since the cylindrical stator 23 is deformed in the radial direction by the core alone, the housing 25 needs rigidity to suppress deformation of the stator 23.

It is desirable to use a light metal such as aluminum or a magnesium alloy for the housing 25 to reduce the weight. In a structure in which a reinforcing material such as a rib is provided in the housing 25 to increase rigidity, the structure is compatible with aluminum or the like having high specific strength (strength per unit weight).

The housing 25 may be air-cooled but includes a flow path of a liquid refrigerant inside the housing 25 in order to increase the power density. The housing 25 is configured to cool the motor 2 with a liquid refrigerant such as mineral oil or ATF, and to cool various gears by causing the liquid refrigerant after cooling the motor 2 to flow also to the distribution mechanism 6.

### Rotor Core 24b

The rotor core 24b has a cylindrical shape longer in a radial direction that is a lateral direction including the front direction F, the back direction B, the right direction R, and the left direction L than in the axial direction. The rotor core 24b is manufactured by laminating electromagnetic steel sheets. In the rotor core 24b, a plurality of core plates of magnetic substance extending in a direction orthogonal to a central axis extending vertically are laminated in the axial direction.

### Rotor Cylindrical Portion 24a

The rotor cylindrical portion 24a supports the rotor 24 and is rotatably supported by the housing 25 through a bearing 30. The rotor cylindrical portion 24a is a cylindrical member. The rotor cylindrical portion 24a extends in the axial direction. The rotor cylindrical portion 24a holds the rotor core 24b from the inner circumferential side. The connecting portion 22 is connected to the axial center of the rotor cylindrical portion 24a.

The inner diameter of the rotor cylindrical portion 24a is larger than the outer diameter of the bevel gear 4.

The rotor cylindrical portion 24a is defined as a rotating body including a bearing 30 for supporting rotation of the rotor 24. In the shown example, the bearing 30 is provided on the upper side and the lower side of the rotor core 24b, but may be provided only on one of the upper side and the lower side of the rotor core 24b. The rotor cylindrical portion 24a is connected to the gear shaft of the bevel gear 4 described above through the connecting portion 22. The material of the rotor cylindrical portion 24a may be light metal such as aluminum depending on the size, in addition to carbon steel, SUS, or the like.

Since the rotor 24 has a large-diameter cylindrical shape, a rib extending in the radial direction is required to prevent deformation in the radial direction. The rotor cylindrical portion 24a has a function of rotation transmission and a function of a rib for preventing radial deformation. In the rotor 24, the rotor cylindrical portion 24a and the rotor core 24b are preferably connected, and the rotor core 24b is preferably attached to the rotor cylindrical portion 24a made of aluminum or the like also for suppressing deformation in the radial direction of the rotor core 24b.

### First Recessed Portion 27a and Second Recessed Portion 27b

On the radially inner circumferential side of the rotor 24 on both axial sides of the housing 25, a pair of first recessed portion 27a and second recessed portion 27b recessed in the axial direction are formed.

One first recessed portion 27a of the pair of first recessed portion 27a and second recessed portion 27b is formed by recessing the lower surface of the housing 25 in the upward direction U in accordance with the rotor cylindrical portion 24a showing an H-shaped cross section and the connecting portion 22, on the axially lower side of the housing 25. The distribution mechanism 6 is disposed in the first recessed portion 27a. Specifically, the first recessed portion 27a houses the bevel gear 4, a part of the ring gear 5, a part of the distribution mechanism 6, and a part of the differential case 7.

The other second recessed portion 27b of the pair of first recessed portion 27a and second recessed portion 27b is formed by recessing the upper surface of the housing 25 in the downward direction D in accordance with the rotor cylindrical portion 24a showing an H-shaped cross section and the connecting portion 22, on the axially upper side of the housing 25. The inverter 3 is disposed in the second recessed portion 27b. Specifically, the inverter 3 is completely housed in the second recessed portion 27b. An axially upper end portion of the gear shaft 41 protrudes in the middle of the axial depth of the second recessed portion 27b.

### Cooling Structure of Motor

Next, a cooling structure of the motor 2 will be described. FIG. 6A is an enlarged cross-sectional perspective view in which a rotor is excluded from the motor according to the first embodiment of the present invention. FIG. 6B is an enlarged view of the VIB portion in FIG. 6A.

The stator core 23a includes a core back portion 23a1 showing a cylindrical shape on the radially outer side of the stator core 23a, a plurality of teeth 23c protruding radially inward from the core back portion 23a1, and a plurality of respective slots 23d formed between the plurality of teeth 23c. A coil 23b is inserted into each of the plurality of slots 23d. The end portion on the radially inner side (rotor side) of the coil 23b is positioned radially outward from the end portion on the radially inner side (rotor side) of the teeth 23c. That is, the slot 23d is in a state of being recessed radially outward from the end portion on the radially inner side (rotor side) of the teeth 23c in the state where the coil 23b is inserted.

The upper half body 25a of the housing 25 is provided with an upper flow path forming body 251 extending downward so as to be in contact with the upper portion of the teeth 23c of the stator core 23a. The upper flow path forming body 251 connects the housing 25 and the upper end surface on the gap G side of the stator core 23a, and is formed in an annular shape inside the housing 25. In the upper portion of the stator core 23a (coil 23b), an upper flow path 252 is formed by the housing 25, the upper end surface of the stator core 23a, and the upper flow path forming body 251. The upper flow path 252 is formed in an annular shape inside the housing 25.

In the upper portion of the slot 23d, a plurality of refrigerant jetting ports 253 communicating with the upper flow path 252 are disposed. The refrigerant jetting port 253 is formed by the upper flow path forming body 251, the teeth 23c, and the slot 23d.

The lower half body 25b of the housing 25 is provided with a lower flow path forming body 254 extending upward so as to be in contact with the lower portion of the teeth 23c of the stator core 23a. The lower flow path forming body 254 connects the housing 25 and the lower end surface on the gap G side of the stator core 23a, and is formed in an annular shape inside the housing 25. In the lower portion of the stator core 23a (coil 23b), a lower flow path 255 is formed by the housing 25, the lower end surface of the stator core 23a, and the lower flow path forming body 254. The lower flow path 255 is formed in an annular shape inside the housing 25.

In the lower portion of the slot 23d, a plurality of refrigerant receiving ports 256 communicating with the lower flow path 255 are disposed. The refrigerant receiving port 256 is formed by the lower flow path forming body 254, the teeth 23c, and the slot 23d.

Then, on the inner side (rotor side) of the slot 23d, as indicated by an arrow in FIG. 6A, a slot flow path 257 communicating the upper flow path 252 and the lower flow path 255 through the refrigerant jetting port 253 and the refrigerant receiving port 256 is formed. In the slot flow path 257, at least a part of an end surface on the gap G side with the rotor core 24b is opened.

The cross-sectional area in the direction orthogonal to the rotation axis of the upper flow path 252 is larger than the sum of the cross-sectional areas in the direction orthogonal to the rotation axis of the plurality of slot flow paths 257. Accordingly, the liquid refrigerant can be jetted from the plurality of slot flow paths 257 in a well-balanced manner.

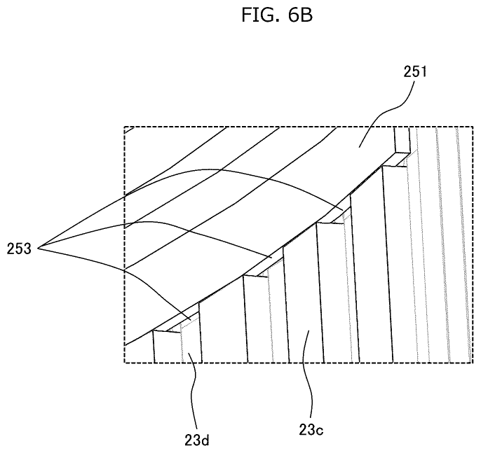

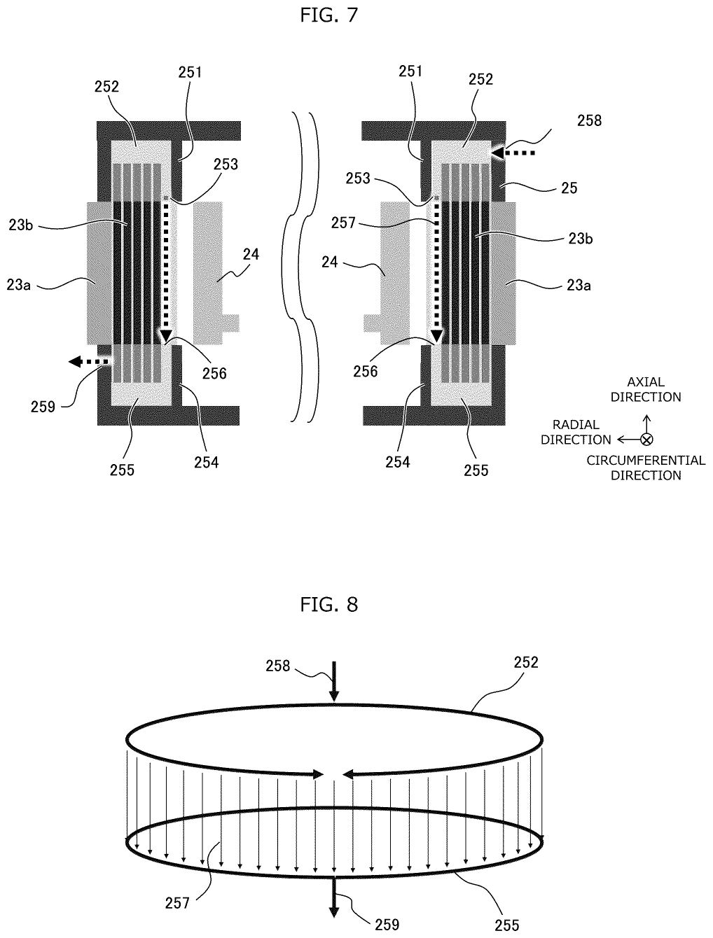

Next, the flow of the liquid refrigerant will be described with reference to FIGS. 7 and 8. FIG. 7 is a schematic cross-sectional view of a part of the motor according to the first embodiment of the present invention. FIG. 8 is a schematic view showing the flow of a liquid refrigerant according to the first embodiment of the present invention. In an upper portion of the housing 25, a flow path inlet 258 communicating with the upper flow path 252 is formed. In addition, in a lower portion of the housing 25, a flow path outlet 259 communicating with the lower flow path 255 is formed. The flow path inlet 258 and the flow path outlet 259 are connected to an oil cooler (not shown) through a pipe, and pressure-feed the liquid refrigerant to the motor 2 by driving a refrigerant pump.

In the present embodiment, the rotation axis of the rotor shaft 26 is disposed along the vertical direction. The liquid refrigerant pressure-fed by the refrigerant pump flows into the upper flow path 252 from the flow path inlet 258, and is divided into the left-right directions to flow through the upper flow path 252. The liquid refrigerant flowing through the upper flow path 252 drops by gravity from the plurality of refrigerant jetting ports 253, and flows downward along the surface of the coil 23b by surface tension in the slot flow path 257. The liquid refrigerant flowing through the slot flow path 257 comes into contact with the surface of the coil 23b and takes heat away from the coil 23b. Accordingly, the coil 23b is cooled by the liquid refrigerant.

The liquid refrigerant having cooled the coil 23b flows into the lower flow path 255 from the refrigerant receiving port 256, and is discharged to the outside of the motor 2 from the flow path outlet 259 communicating with the lower flow path 255. The discharged liquid refrigerant is cooled by the oil cooler and flows toward the upper flow path 252 again.

In the present embodiment, the liquid refrigerant having flowed into the upper flow path 252 from the flow path inlet 258 branches into the left-right directions and flows, and the liquid refrigerant collides with each other on the radially opposite side of the flow path inlet 258. As described above, by causing the refrigerant to flow while branching into the left-right directions, variations in the flow rate of the liquid refrigerant flowing through the slot flow path 257 can be suppressed. In addition, in the present embodiment, the flow path outlet 259 is disposed to be shifted to the opposite side by 180° with respect to the flow path inlet 258. With this configuration, the flow path length including the slot flow path 257 can be made uniform as a whole.

It should be noted that the liquid refrigerant flowing through the upper flow path 252 may be caused to flow in one direction around the upper flow path 252 without branching to the left and right. In this case, the flow rate of the slot flow path has variations, but the flow velocity of the liquid refrigerant increases, and the cooling performance can be improved.

In addition, in the present embodiment, the lower flow path 255 is formed by the lower flow path forming body 254, but the lower flow path 255 may not be provided, and the liquid refrigerant may be directly accumulated as in an oil pan, for example.

Furthermore, in the present embodiment, the rotation axis of the motor 2 (rotor shaft 26) is arranged along the vertical direction, but may be arranged to be tilted from the vertical state. That is, the rotation axis of the rotor shaft may be arranged at a predetermined angle with respect to the horizontal axis.

When the rotation axis of the motor 2 (rotor shaft 26) is disposed to be tilted from the vertical direction, when the slot flow path 257 approaches the horizontal direction, the gravity is stronger than the force to stay in the slot 23d due to the surface tension, and the liquid refrigerant drips to the rotor 24 side. Accordingly, the liquid refrigerant is applied to the rotor, the fluid friction loss slightly increases, and the coil heat dissipation decreases, but the tilting angle may be large as long as there is no problem in performance.

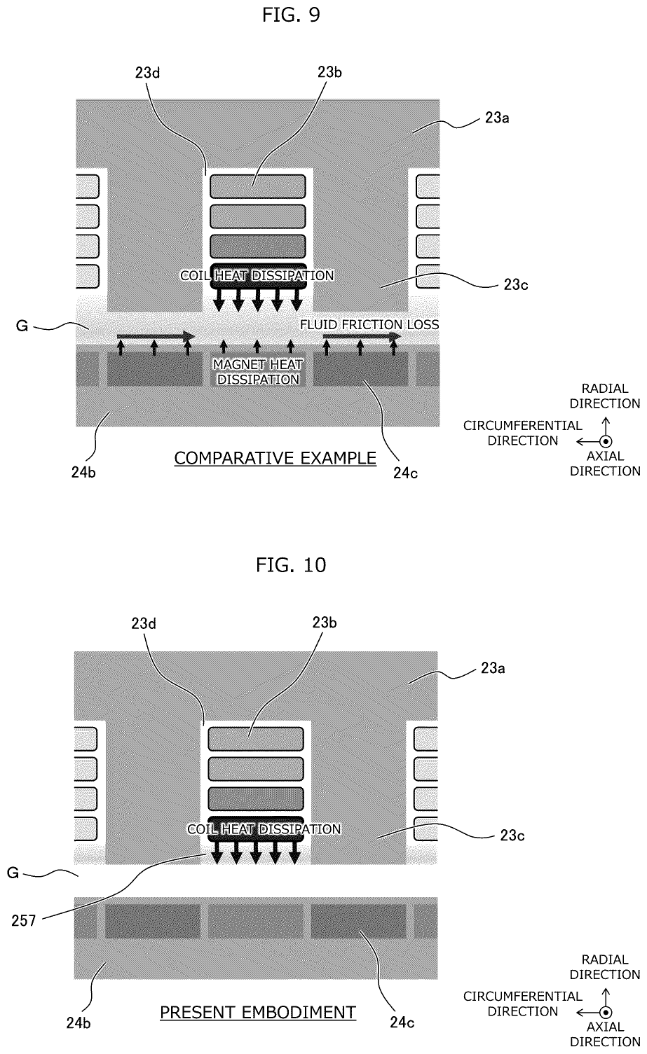

Next, the effects of the present invention will be described. FIG. 9 is a schematic view of a part of the motor 2 according to a comparative example as viewed from the axial direction. FIG. 10 is a schematic view of a part of the motor 2 according to the first embodiment of the present invention as viewed from the axial direction. In FIGS. 9 and 10, the stator 23 and the rotor 24 are illustrated linearly for convenience.

A plurality of magnets 24c are disposed in the rotor core 24b of the rotor 24. The coil 23b disposed in the slot 23d generates heat when a current flows. In the temperature distribution of heat generation, the temperature on the rotor 24 side (radially inner side) is high, and the temperature decreases as it goes toward the anti-rotor side (radially outer side). When cooling the coil 23b, it is preferable to actively cool the rotor 24 side (radially inner side) having a high temperature. In the comparative example shown in FIG. 9, the inside of the housing 25 is filled with a liquid refrigerant. There is a gap G between the stator 23 and the rotor 24, and the liquid refrigerant flows also into the gap G. The coil 23b radiates heat toward the liquid refrigerant in the gap G and is cooled. In addition, the magnet of the rotor 24 generates heat due to the occurrence of eddy current, but is heat-dissipated toward the liquid refrigerant in the gap G and cooled. In the comparative example, the stator 23 and the rotor 24 are cooled by the liquid refrigerant in which they are immersed. However, in the comparative example, when the rotor 24 rotates, the rotor rotates while being in contact with the liquid refrigerant in the gap G, so that the liquid refrigerant in the gap G becomes a rotational resistance, and fluid friction loss occurs. Therefore, in the comparative example, since the rotor 24 receives fluid friction loss, the motor efficiency decreases.

On the other hand, in the present embodiment, since the presence of the liquid refrigerant in the gap G between the stator 23 and the rotor 24 can be reduced, fluid friction loss when the rotor 24 rotates can be reduced. In addition, in the present embodiment, since the liquid refrigerant is caused to flow through the slot flow path 257 positioned on the rotor 24 side where the heat generation of the coil 23b is the highest, it is possible to suppress a decrease in motor efficiency and to efficiently cool the coil 23b. In the present embodiment, a square-shaped coil is used, but the coil may be round-shaped, and the type of coil does not matter. In addition, the coil may be concentrated winding or distributed winding.

According to the present embodiment, it is possible to provide a rotating electric machine in which a structure for cooling is simplified and an increase in production cost is suppressed.

### Second Embodiment

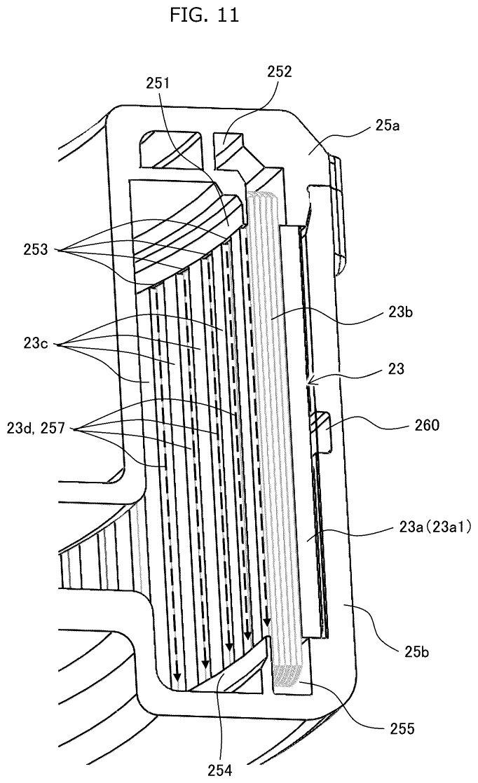

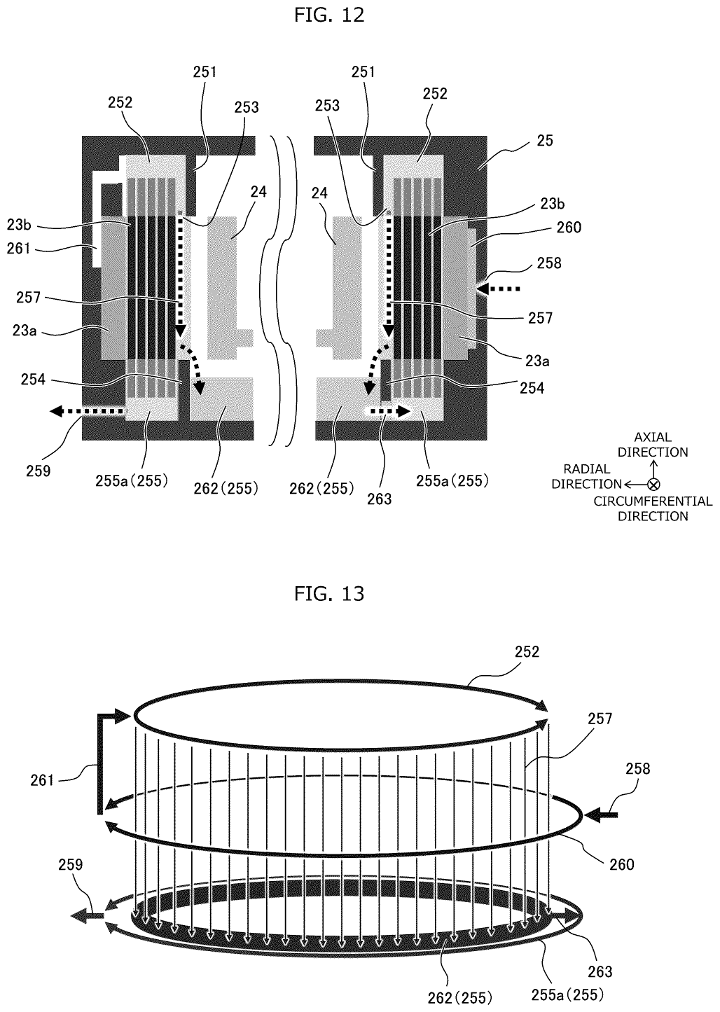

Next, a second embodiment of the present invention will be described with reference to FIGS. 11 to 13. FIG. 11 is an enlarged cross-sectional perspective view in which a rotor is excluded from the motor according to the second embodiment of the present invention. FIG. 12 is a schematic cross-sectional view of a part of the motor according to the second embodiment of the present invention. FIG. 13 is a schematic view showing the flow of a liquid refrigerant according to the second embodiment of the present invention. The components common to those of the first embodiment are denoted by the same reference numerals, and the detailed description thereof will be omitted.

In the second embodiment, the position of the flow path inlet 258 is different from that in the first embodiment. In addition, the lower flow path 255 includes a lower coil end flow path 255a and a refrigerant aggregating portion 262.

As shown in FIGS. 12 and 13, a flow path inlet 258 is formed at the center in the axial direction (vertical direction) of the housing 25. In addition, an annular flow path 260 is formed between the stator core 23a and the housing 25. The annular flow path 260 is formed along the entire circumference in the circumferential direction of the stator core 23a. A side surface flow path 261 extending in the upward direction is formed between the stator core 23a and the housing 25. The side surface flow path 261 is positioned on the radially opposite side (180°) with respect to the flow path inlet 258, and communicates with the annular flow path 260 and the upper flow path 252.

A refrigerant aggregating portion 262 in which the liquid refrigerant collects is provided in a lower portion of the housing 25. In addition, the lower flow path forming body 254 is formed with a partially cut-out communication port 263. In the present embodiment, the flow path outlet 259 is arranged to be shifted to the radially opposite side (180°) with respect to the flow path inlet 258.

The motor 2 is disposed so that the rotation axis is along the vertical direction. The liquid refrigerant pressure-fed by the refrigerant pump flows into the annular flow path 260 from the flow path inlet 258, branches into the left-right directions, and joins on the radially opposite side. The joined liquid refrigerant rises in the side surface flow path 261, flows into the upper flow path 252, and is divided into the left and right directions to flow through the upper flow path 252. The liquid refrigerant flowing through the upper flow path 252 drops by gravity from the plurality of refrigerant jetting ports 253, and flows downward along the surface of the coil 23b by surface tension in the slot flow path 257. The liquid refrigerant flowing through the slot flow path 257 comes into contact with the surface of the coil 23b and takes heat away from the coil 23b. The coil 23b is cooled by the liquid refrigerant.

The liquid refrigerant that has cooled the coil 23b accumulates in the refrigerant aggregating portion 262 (lower flow path 255) in the lower portion of the motor 2, passes through the communication port 263 formed in the lower flow path forming body 254, and flows into the lower coil end flow path 255a (lower flow path 255). The communication port 263 is on the same side as the flow path inlet 258. The liquid refrigerant flowing into the lower coil end flow path 255a (lower flow path 255) is divided into the left and right directions and joins on the radially opposite side. The joined liquid refrigerant is discharged to the outside of the motor 2 from the flow path outlet 259 communicating with the lower coil end flow path 255a (lower flow path 255). The discharged liquid refrigerant is cooled by the oil cooler and flows toward the annular flow path 260 again.

In the present embodiment, the liquid refrigerant flowing through the annular flow path 260 flows in a direction opposite to that of the liquid refrigerant flowing through the upper flow path 252. The liquid refrigerant increases in temperature due to heat transfer from the heat generator with increasing distance from the inlet. Therefore, in the present embodiment, by reversing the direction of the flow of the liquid refrigerant flowing through the annular flow path 260 and the upper flow path 252, the average temperature of the stator core 23a and the coil 23b can be made uniform as a whole.

### Third Embodiment

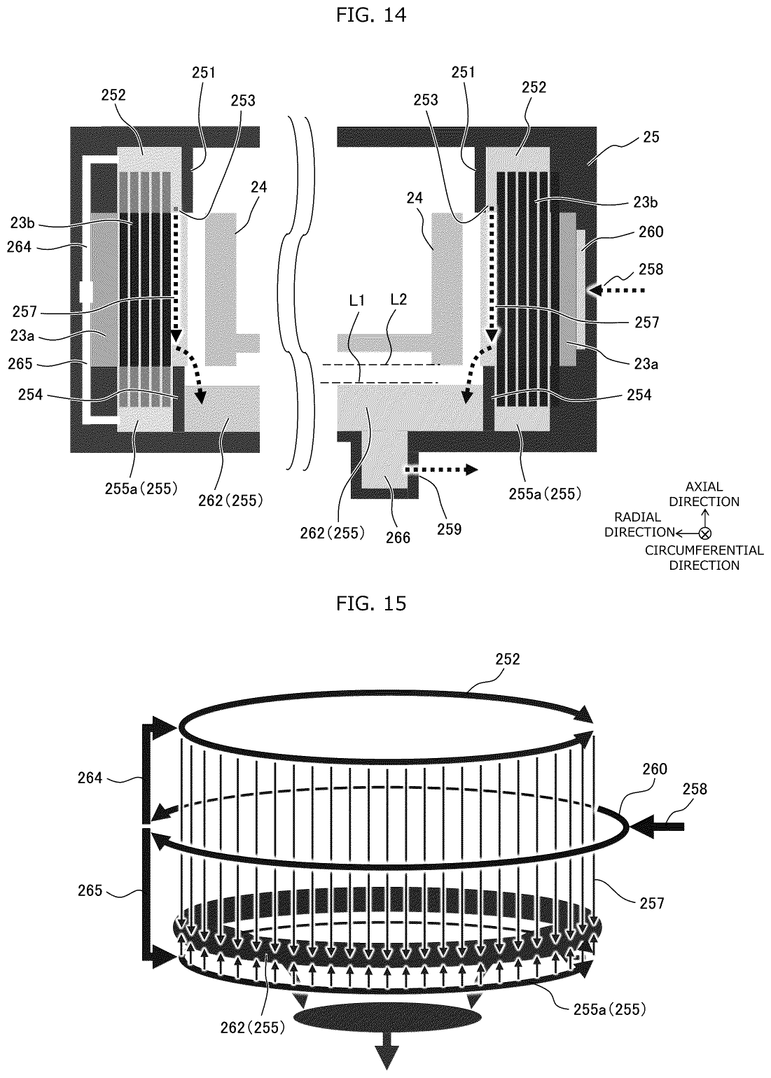

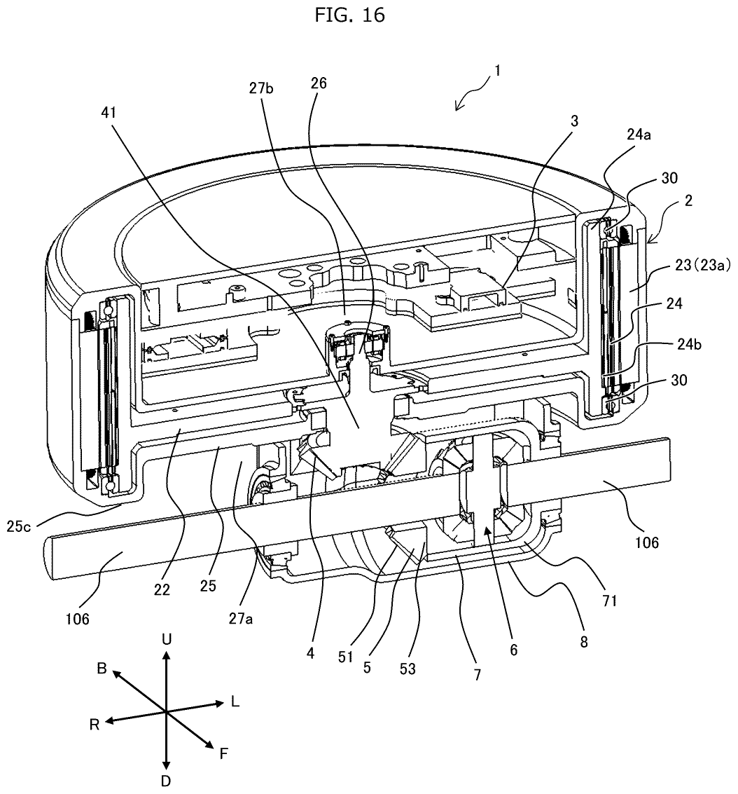

Next, a third embodiment of the present invention will be described with reference to FIGS. 11, 14, and 15. FIG. 14 is a schematic cross-sectional view of a part of the motor according to the third embodiment of the present invention. FIG. 15 is a schematic view showing the flow of a liquid refrigerant according to the third embodiment of the present invention. The components common to those of the first and second embodiments are denoted by the same reference numerals, and the detailed description thereof will be omitted.

The third embodiment is different from the first and second embodiments in that the liquid refrigerant discharged from the annular flow path 260 branches upward and downward to flow. In addition, the lower flow path 255 includes a lower coil end flow path 255a and a refrigerant aggregating portion 262.

As shown in FIGS. 14 and 15, a flow path inlet 258 is formed at the center in the axial direction (vertical direction) of the housing 25. In addition, an annular flow path 260 is formed between the stator core 23a and the housing 25. The annular flow path 260 is formed along the entire circumference in the circumferential direction of the stator core 23a. A side surface upward flow path 264 extending in the upward direction and a side surface downward flow path 265 extending in the downward direction are formed between the stator core 23a and the housing 25. The side surface upward flow path 264 and the side surface downward flow path 265 are positioned on the radially opposite side (180°) with respect to the flow path inlet 258. The side surface upward flow path 264 communicates with the annular flow path 260 and the upper flow path 252, and the side surface downward flow path 265 communicates with the annular flow path 260 and the lower coil end flow path 255a (lower flow path 255). In other words, the side surface upward flow path 264 and the side surface downward flow path 265 branch the annular flow path 260 in the vertical direction.

In addition, a lower portion of the housing 25 is provided with a refrigerant aggregating portion 262 (lower flow path 255) in which the liquid refrigerant collects, and an oil pan 266 that descends downward from the refrigerant aggregating portion 262. In the present embodiment, the side surface upward flow path 264 and the side surface downward flow path 265 are arranged to be shifted to the radially opposite side (180°) with respect to the flow path inlet 258.

The rotation axis of the motor 2 (rotor shaft 26) is disposed along the vertical direction. The liquid refrigerant pressure-fed by the refrigerant pump flows into the annular flow path 260 from the flow path inlet 258, branches into the left-right directions, and joins on the radially opposite side.

A part of the joined liquid refrigerant rises in the side surface upward flow path 264, flows into the upper flow path 252, and is divided into the left and right directions to flow through the upper flow path 252. The liquid refrigerant flowing through the upper flow path 252 drops by gravity from the plurality of refrigerant jetting ports 253, and flows downward along the surface of the coil 23b by surface tension in the slot flow path 257. The liquid refrigerant flowing through the slot flow path 257 comes into contact with the surface of the coil 23b and takes heat away from the coil 23b. The coil 23b is cooled by the liquid refrigerant.

In addition, a part of the joined liquid refrigerant flows down the side surface downward flow path 265, flows into the lower coil end flow path 255a (lower flow path 255), and is divided into the left and right directions to flow through the lower coil end flow path 255a. Since the liquid refrigerant flowing through the lower coil end flow path 255a is pressure-fed by the refrigerant pump, the liquid refrigerant is jetted from the gap between the lower flow path forming body 254 and the slot flow path 257 and flows into the refrigerant aggregating portion 262. In addition, the liquid refrigerant flowing through the lower coil end flow path 255a cools the lower portion of the coil 23b.

The liquid refrigerant having flowed into the refrigerant aggregating portion 262 is accumulated in the oil pan 266 and discharged to the outside of the motor 2 from the flow path outlet 259 communicating with the oil pan 266. The discharged liquid refrigerant is cooled by the oil cooler and flows toward the annular flow path 260 again.

In a state where the rotor 24 rotates and the liquid refrigerant circulates in the motor 2, the liquid level height L1 of the liquid refrigerant accumulated in the refrigerant aggregating portion 262 (lower flow path 255) is lower than the bottom surface position L2 of the rotor core 24b. In this way, the rotor core 24b can be prevented from coming into contact with the liquid refrigerant, and the fluid friction loss can be reduced.

In the present embodiment, since the liquid refrigerant pressure-fed by the refrigerant pump is branched in the vertical direction of the stator core 23a and pressure-fed to the upper flow path 252 and the lower flow path 255, the flow velocity of the liquid refrigerant flowing through the upper flow path 252 and the lower flow path 255 can be increased, and the cooling efficiency can be improved.

### Fourth Embodiment

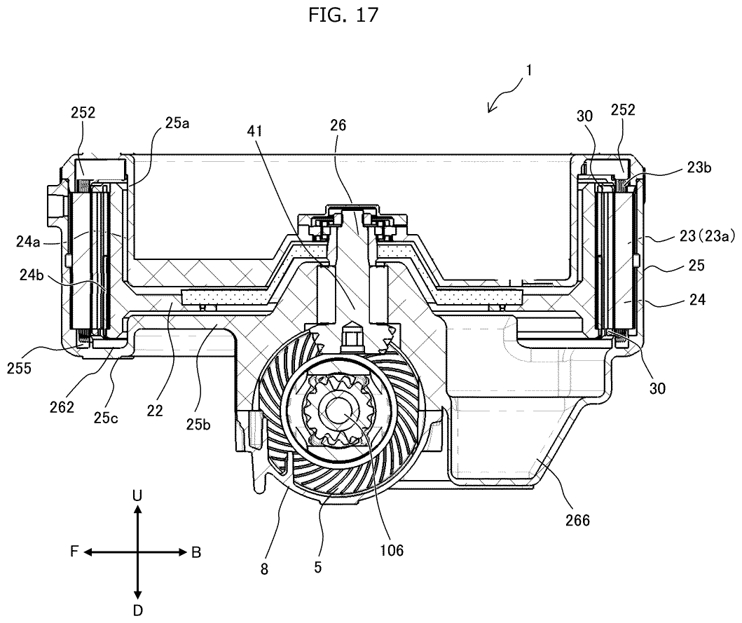

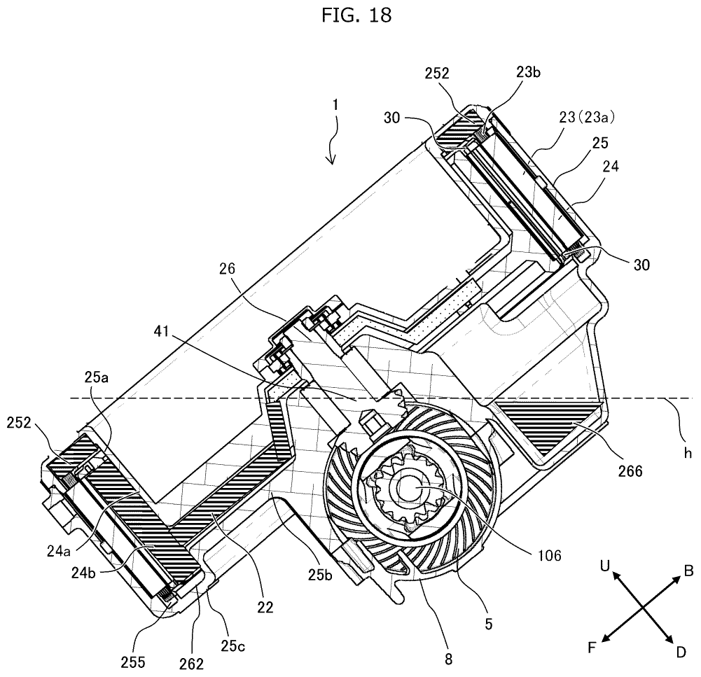

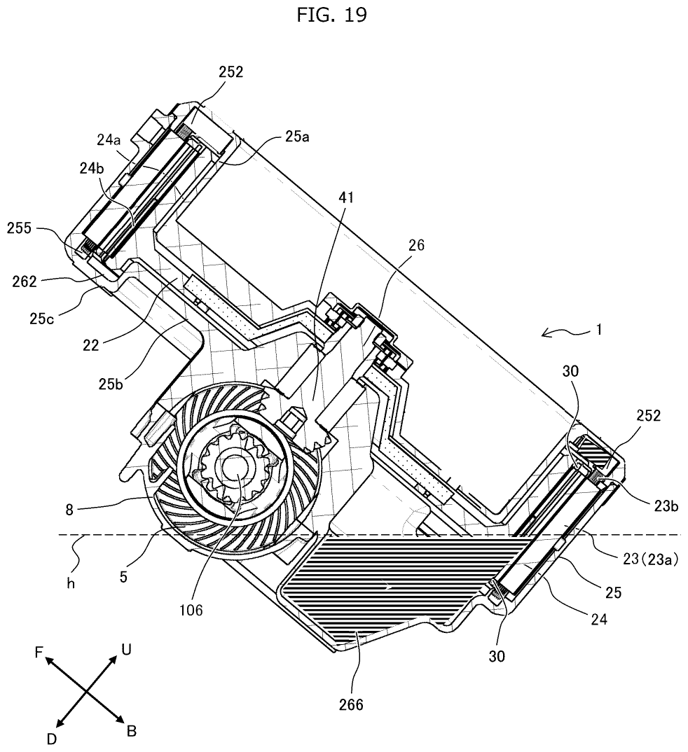

Next, a fourth embodiment of the present invention will be described with reference to FIGS. 16 to 19. FIG. 16 is a perspective view cut in half in a longitudinal section showing the drive unit 1 according to the fourth embodiment of the present invention. FIG. 17 is a cross-sectional view of the drive unit 1 according to the fourth embodiment of the present invention as viewed from the drive shaft 106 side. FIG. 18 is a cross-sectional view of the drive unit 1 when the vehicle is in a deceleration state or a hill-descending state. FIG. 19 is a cross-sectional view of the drive unit 1 when the vehicle is in an acceleration state or a hill-ascending state.

The components common to those of the first to third embodiments are denoted by the same reference numerals, and the detailed description thereof will be omitted. FIGS. 16 to 19 show a drive unit for a vehicle.

In the present embodiment, the ring gear 5 is directly fastened to the differential case 7. Therefore, the ring gear 5 and the distribution mechanism 6 are arranged side by side in the radial direction on one side with respect to the rotation axis (rotation central axis O) of the motor 2.

The ring gear 5 is disposed so that a rotation center of the ring gear 5 faces an inner diameter direction in a right direction R which is a rotation axis (rotation central axis O) side of the motor 2. The ring gear 5 includes a gear tooth surface portion 51 facing the right direction R and having gear teeth at a predetermined taper angle, and a radially back surface portion 53 provided on the left direction L side with respect to the gear tooth surface portion 51. The radially back surface portion 53 has no teeth of the ring gear 5 and is connected to the large cylindrical portion 71.

The large cylindrical portion 71 of the differential case 7 is connected to the toothless radially back surface portion 53 of the ring gear 5 and covers the distribution mechanism 6.

In addition, the drive unit 1 of the present embodiment includes an oil pan 266 as in the third embodiment. The oil pan 266 and the distribution mechanism 6 are disposed adjacent to each other.

The differential case 7 is filled with differential oil. When in a low-temperature state, the differential oil has low viscosity and large friction loss. Since the highest temperature liquid refrigerant after absorbing the heat of the motor 2 is collected in the oil pan 266, the heat of the liquid refrigerant is transferred to the differential oil by adjoining the oil pan 266 and the distribution mechanism 6 including the differential case 7. In the present embodiment, since the oil pan 266 and the distribution mechanism 6 are arranged adjacent to each other, the differential oil can be warmed, and the friction loss of the distribution mechanism 6 can be reduced. Furthermore, in the present embodiment, since the liquid refrigerant can exchange heat with the distribution mechanism 6, the liquid refrigerant can be cooled, and the cooling efficiency of the motor 2 can be enhanced.

In addition, in the present embodiment, the oil pan 266 adjacent to the distribution mechanism 6 is disposed on the vehicle-body back side of the center of the motor 2. The traveling vehicle 100 performs acceleration, deceleration, hill-ascending, and hill-descending depending on a road environment and a traffic environment.

For example, when the vehicle 100 is in the deceleration state or the hill-descending state as shown in FIG. 18, since the vehicle is in the forward-tilting attitude so that the front side of the vehicle body sinks, the drive unit 1 is also in the forward-tilting attitude. Since the liquid refrigerant is flowing in the motor 2 of the drive unit 1, the liquid refrigerant is also shifted to the front side so as not to exceed the liquid level height h according to the forward-tilting attitude of the drive unit 1. Since the rotor core 24b positioned on the front side is immersed in the liquid refrigerant biased to the front side, the flow path friction loss increases. According to the present embodiment, when the vehicle 100 is in the deceleration state or the hill-descending state, the brake action can be obtained using the flow path friction loss of the rotor core 24b, so that the wear of the brake pad can be reduced in addition to the cooling of the motor 2.

On the other hand, for example, when the vehicle 100 is in the acceleration state or the hill-ascending state as shown in FIG. 19, since the vehicle is in the backward-tilting attitude so that the back side of the vehicle body sinks, the drive unit 1 is also in the backward-tilting attitude. Since the liquid refrigerant is flowing in the motor 2 of the drive unit 1, the liquid refrigerant is also shifted to the back side so as not to exceed the liquid level height h according to the backward-tilting attitude of the drive unit 1. Since the oil pan 266 is disposed on the vehicle-body back side of the center of the motor 2, the liquid refrigerant remains in the oil pan 266, and the liquid refrigerant is prevented from flowing to the rotor core 24b, so that a flow path friction loss can be reduced. When the vehicle 100 is in the acceleration state or the hill-ascending state, the torque of the motor 2 needs to be increased.

According to the present embodiment, when the vehicle 100 is in the acceleration state or the hill-ascending state, the fluid friction loss generated by the liquid refrigerant contacting the rotor core 24b can be reduced, so that the acceleration performance and the hill-ascending performance of the vehicle 100 can be improved.

It should be noted that the present invention is not limited to the embodiments described above, and includes various modifications. For example, the above-described embodiments are described in detail for easy understanding of the present invention, and are not necessarily limited to those including all the configurations described. In addition, part of the configuration of one embodiment can be replaced with the configuration of another embodiment, and the configuration of another embodiment can be added to the configuration of one embodiment. In addition, it is possible to add, delete, and replace another configuration with respect to a part of the configuration of each of the embodiments.

### REFERENCE SIGNS LIST

1 drive unit
2 motor
3 inverter
4 bevel gear
5 ring gear
6 distribution mechanism
7 differential case
8 differential housing
22 connecting portion
23 stator
23a stator core
23a1 core back portion
23b coil
23c tooth
23d slot
24 rotor
24a rotor cylindrical portion
24b rotor core
25 housing
25a upper half body
25b lower half body
25c outer circumferential lower surface
26 rotor shaft
27a first recessed portion
27b second recessed portion
30 bearing
41 gear shaft
51 gear tooth surface portion
52 inner circumferential surface portion
71 large cylindrical portion
72 small cylindrical portion
100 vehicle
101 chassis
102 support member
103 wheel
104 wheel
105 battery
106 drive shaft
251 upper flow path forming body
252 upper flow path
253 refrigerant jetting port
254 lower flow path forming body
255 lower flow path
255a lower coil end flow path
256 refrigerant receiving port
257 slot flow path
258 flow path inlet
259 flow path outlet
260 annular flow path
261 side surface flow path
262 refrigerant aggregating portion
263 communication port
264 side surface upward flow path
265 side surface downward flow path
266 oil pan

1. A rotating electric machine comprising:
a stator core having a cylindrical shape, the stator core having a plurality of slots into which coils are mounted;
a rotor core facing the stator core in a radial direction of the stator core with interposition of a predetermined gap;
a rotor shaft configured to rotate together with the rotor core; and
a housing configured to house the stator core, the rotor core, and the rotor shaft,
wherein a rotation axis of the rotor shaft is disposed at a predetermined angle with respect to a horizontal axis,
the rotating electric machine further comprises:
an upper flow path which is formed on an upper side of the stator core and through which a liquid refrigerant flows,
a lower flow path formed on a lower side of the stator core, and
a slot flow path communicating the upper flow path and the lower flow path,
the upper flow path is formed by the housing, an upper end surface of the stator core, and an upper flow path forming body that connects the housing and an upper end surface on a gap side of the stator core, and
in the slot flow path, at least a part of an end surface on the gap side is opened.

2. The rotating electric machine according to claim 1, wherein the rotation axis is disposed in a vertical direction.

3. The rotating electric machine according to claim 1, wherein a cross-sectional area of the upper flow path is larger than a sum of cross-sectional areas of the slot flow paths.

4. The rotating electric machine according to claim 1, wherein
the lower flow path includes a lower coil end flow path through which the liquid refrigerant is pressure-fed and a refrigerant aggregating portion through which the liquid refrigerant is not pressure-fed, and
the liquid refrigerant is branched into the upper flow path and the lower coil end flow path and pressure-fed.

5. The rotating electric machine according to claim 1, further comprising an annular flow path between the housing and the stator core, and
wherein in the annular flow path, a liquid refrigerant flows in a direction opposite to that of the upper flow path.

6. The rotating electric machine according to claim 4, wherein a liquid level height of the refrigerant aggregating portion is lower than a bottom surface of the rotor core.

7. A drive unit of a vehicle comprising the rotating electric machine according to claim 1.

8. The drive unit of a vehicle according to claim 7, further comprising:
an oil pan disposed below the lower flow path, and
a distribution mechanism configured to transmit a driving force of the rotating electric machine to an axle,
wherein the oil pan and the distribution mechanism are disposed adjacent to each other.

9. The drive unit of a vehicle according to claim 8, wherein the oil pan is disposed on a vehicle-body back side of a center of the rotating electric machine.
